(19) United States
(12) Patent Application Publication
(10) Pub. No.: US 2011/0276535 A1
(43) Pub. Date: Nov. 10, 2011

(54) KNOWLEDGE ARTICLE WORKFLOW MANAGEMENT

(75) Inventors: Olivier Pin, San Francisco, CA (US); Etienne Giraudy, San Francisco, CA (US); Orjan Kjellberg, Walnut Creek, CA (US); Mark Fischer, Ashland, OR (US); Steven Tamm, San Francisco, CA (US); Varadarajan Rajaram, San Francisco, CA (US)

(73) Assignee: salesforce.com, inc., San Francisco, CA (US)

(21) Appl. No.: 12/895,833

(22) Filed: Sep. 30, 2010

Related U.S. Application Data
(60) Provisional application No. 61/331,762, filed on May 5, 2010.

(51) Int. Cl. G06F 17/00

(52) U.S. Cl. 707/608; 707/E17.005

(57) ABSTRACT

A computer implemented method a document management workflow in a multi-tenant system environment is disclosed. The method includes receiving instructions to create a composition a document. The document is encapsulated in a knowledge article version and the knowledge article version having a document category. The knowledge article version is associated with a knowledge article. The method further includes invoking the document management workflow that is specific to the knowledge article, the knowledge article version and the document category and configuring the document management workflow to include a plurality of workflow steps based on the knowledge article, the knowledge article version and the document category. Each of the plurality of workflow steps are then associated with one or more triggers and actor roles. The actor roles define permissible actions in each of the plurality of workflow steps. Data in the knowledge article and the knowledge article version are configured to be updated with the movement of a document in the plurality of workflow steps. The document management workflow provides cyclic processing steps with no termination state.

### CROSS REFERENCE TO RELATED APPLICATIONS

This application claims the benefit of U.S. Provisional Application No. 61/331,762 filed on May 5, 2010, which is incorporated herein by reference.

### BACKGROUND

Embodiments relate generally to a task workflow, and more particularly to the management the workflow for the digital publication of knowledge articles.

The process of creating, modifying, translating, securing documents may vary not only from one customer to the other, but also from one type of documents to the other, depending on the document complexity. This process of creating, modifying, translating and publishing documents at times needs to be secured, for example, the process may involve collaborative efforts from multiple users, some of whom may not be authorized to parts of the process.

Existing workflow processes typically have a predetermined life cycle, in that a workflow item entering a workflow does not re-enter the workflow after the completion of the task. For example, when an invoice goes through a workflow involving various intermediate actions on the invoice, the invoice does not re-enter the workflow after the invoice is approved for payment.

Still further, the existing workflow techniques do not take into account a multi-tenant database environment, which typically hosts logically separate data, security, and processes belonging to different business entities.

### DESCRIPTION OF THE DRAWINGS

A more particular description of the invention may be had by reference to embodiments, some of which are illustrated in the appended drawings. It is to be noted, however, that the appended drawings illustrate only typical embodiments and are therefore not to be considered limiting of its scope, since there may be other equally effective embodiments. The embodiments are illustrated by way of example, and not by way of limitation, in the figures of the accompanying drawings. Like reference numerals refer to similar elements:

FIG. 1 illustrates an environment in which a multi-tenant database system (MTS) might be used according to one or more embodiments.

FIG. 2 illustrates elements of a MTS and interconnections therein in more detail according to one or more embodiments.

FIG. 3 illustrates a logical structure of a knowledge article in accordance with one or more embodiments.

FIG. 4 illustrates an exemplary user interface to interact with the knowledge article workflow in accordance with one or more embodiments.

FIG. 5 illustrates a logical depiction of an exemplary knowledge management workflow in accordance with one or more embodiments.

FIG. 6 illustrates an exemplary knowledge management workflow in accordance with one or more embodiments.

FIG. 7 illustrates an exemplary logically diagram of the system for managing the knowledge article workflow in accordance with one or more embodiments.

### DETAILED DESCRIPTION

An approach for managing creating, publishing and archiving knowledge article workflow is described. In the following description, for the purposes of explanation, numerous specific details are set forth in order to provide a thorough understanding of one or more embodiments. It will be apparent, however, to one skilled in the art that the one or more embodiments may be practiced without these specific details. In other instances, well-known structures and devices are illustrated in block diagram form in order to avoid unnecessarily obscuring implementations.

In the following description, numerous specific details are set forth to provide a more thorough understanding of implementations. However, it will be apparent to one of skill in the art that the one or more embodiments may be practiced without one or more of these specific details. In other instances, well-known features have not been described in order to avoid obscuring the one or more embodiments.

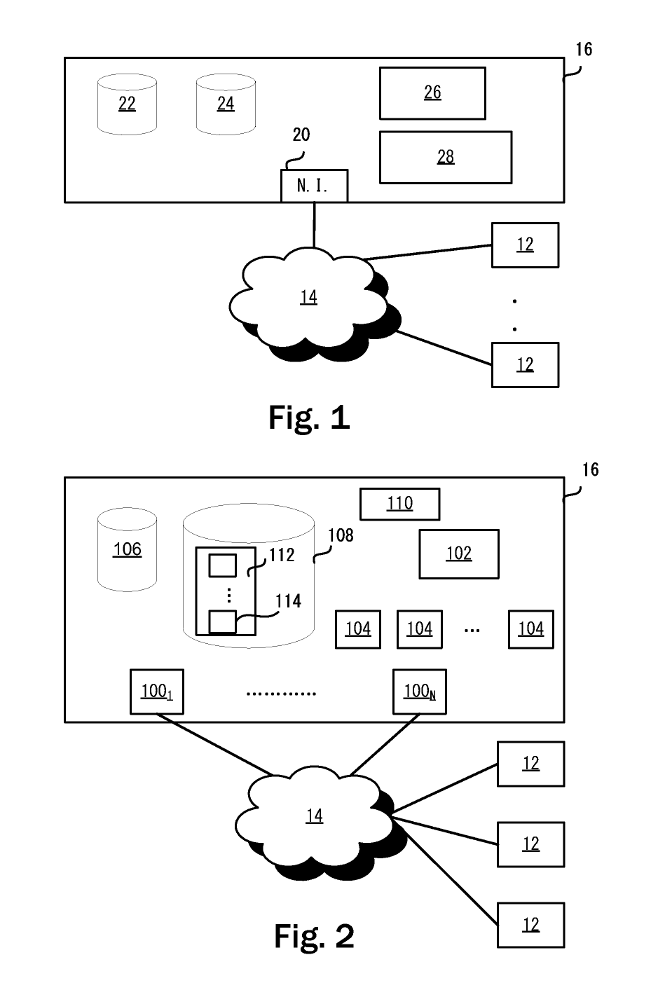

FIG. 1 illustrates an environment in which a multi-tenant database system might be used. As illustrated in FIG. 1 (and in more detail in FIG. 2) any user systems 12 might interact via a network 14 with a multi-tenant database system (MTS) 16. The users of those user systems 12 might be users in differing capacities and the capacity of a particular user system 12 might be entirely determined by the current user. For example, where a salesperson is using a particular user system 12 to interact with MTS 16, that user system has the capacities allotted to that salesperson. However, while an administrator is using that user system to interact with MTS 16, that user system has the capacities allotted to that administrator.

Network 14 can be a LAN (local area network), WAN (wide area network), wireless network, point-to-point network, star network, token ring network, hub network, or other configuration. As the most common type of network in current use is a TCP/IP (Transfer Control Protocol and Internet Protocol) network such as the global internetwork of networks often referred to as the “Internet” with a capital “I,” that will be used in many of the examples herein, but it should be understood that the networks that the present invention might use are not so limited, although TCP/IP is the currently preferred protocol.

User systems 12 might communicate with MTS 16 using TCP/IP and, at a higher network level, use other common Internet protocols to communicate, such as HTTP, FTP, AFS, WAP, etc. As an example, where HTTP is used, user system 12 might include an HTTP client commonly referred to as a “browser” for sending and receiving HTTP messages from an HTTP server at MTS 16. Such HTTP server might be implemented as the sole network interface between MTS 16 and network 14, but other techniques might be used as well or instead. In some implementations, the interface between MTS 16 and network 14 includes load sharing functionality, such as round-robin HTTP request distributors to balance loads and distribute incoming HTTP requests evenly over a plurality of servers. Preferably, each of the plurality of servers has access to the MTS's data, at least as for the users that are accessing that server.

In preferred aspects, the system shown in FIG. 1 implements a web-based customer relationship management (CRM) system. For example, in one aspect, MTS 16 can include application servers configured to implement and execute CRM software applications as well as provide related data, code, forms, web pages and other information to and from user systems 12 and to store to, and retrieve from, a database system related data, objects and web page content. With a multi-tenant system, tenant data is preferably arranged so that data of one tenant is kept separate from that of other tenants so that one tenant does not have access to another's data, unless such data is expressly shared.

One arrangement for elements of MTS 16 is shown in FIG. 1, including a network interface 20, storage 22 for tenant data, storage 24 for system data accessible to MTS 16 and possibly multiple tenants, program code 26 for implementing various functions of MTS 16, and a process space 28 for executing MTS system processes and tenant-specific processes, such as running applications as part of an application service.

Several elements in the system shown in FIG. 1 include conventional, well-known elements that need not be explained in detail here. For example, each user system 12 could include a desktop personal computer, workstation, laptop, PDA, cell phone, or any WAP-enabled device or any other computing device capable of interfacing directly or indirectly to the Internet or other network connection. User system 12 typically runs an HTTP client, e.g., a browsing program, such as Microsoft's Internet Explorer™ browser, Netscape's Navigator™ browser, Opera's browser, or a WAP-enabled browser in the case of a cell phone, PDA or other wireless device, or the like, allowing a user (e.g., subscriber of a CRM system) of user system 12 to access, process and view information and pages available to it from MTS 16 over network 14. Each user system 12 also typically includes one or more user interface devices, such as a keyboard, a mouse, touch screen, pen or the like, for interacting with a graphical user interface (GUI) provided by the browser on a display (e.g., monitor screen, LCD display, etc.) in conjunction with pages, forms and other information provided by MTS 16 or other systems or servers. As discussed above, the one or more embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 12 and all of its components are operator configurable using applications, such as a browser, including computer code run using a central processing unit such as an Intel Pentium processor or the like. Similarly, MTS 16 (and additional instances of MTS's, where more than one is present) and all of their components might be operator configurable using application(s) including computer code run using a central processing unit such as an Intel Pentium processor or the like, or multiple processor units. Computer code for operating and configuring MTS 16 to intercommunicate and to process web pages and other data and media content as described herein is preferably downloaded and stored on a hard disk, but the entire program code, or portions thereof, may also be stored in any other volatile or non-volatile memory medium or device as is well known, such as a ROM or RAM, or provided on any media capable of storing program code, such as a compact disk (CD) medium, digital versatile disk (DVD) medium, a floppy disk, and the like. Additionally, the entire program code, or portions thereof, may be transmitted and downloaded from a software source, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing aspects of the one or more embodiments can be implemented in any programming language that can be executed on a server or server system such as, for example, in C, C++, HTML, Java, JavaScript, any other scripting language, such as VBScript and many other programming languages as are well known.

According to one embodiment, each MTS 16 is configured to provide web pages, forms, data and media content to user systems 12 to support the access by user systems 12 as tenants of MTS 16. As such, MTS 16 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., RDBMS) as is well known in the art. It should also be understood that “server system” and “server” are often used interchangeably herein. Similarly, the databases described herein can be implemented as single databases, a distributed database, a collection of distributed databases, a database with redundant online or offline backups or other redundancies, etc., and might include a distributed database or storage network and associated processing intelligence.

FIG. 2 illustrates elements of MTS 16 and various interconnections in more detail. In this example, the network interface is implemented as one or more HTTP application servers 100. Also shown is system process space 102 including individual tenant process spaces 104, a system database 106, tenant database(s) 108 and a tenant management process space 110. Tenant database 108 might be divided into individual tenant storage areas 112, which can be either a physical arrangement or a logical arrangement. Within each tenant storage area 112, user storage 114 might similarly be allocated for each user.

It should also be understood that each application server 100 may be communicably coupled to database systems, e.g., system database 106 and tenant database(s) 108, via a different network connection. For example, one server 1001 might be coupled via the Internet 14, another server 100N−1 might be coupled via a direct network link, and another server 100N might be coupled by yet a different network connection. Transfer Control Protocol and Internet Protocol (TCP/IP) are preferred protocols for communicating between servers 100 and the database system, however, it will be apparent to one skilled in the art that other transport protocols may be used to optimize the system depending on the network interconnect used.

In preferred aspects, each application server 100 is configured to handle requests for any user/organization. Because it is desirable to be able to add and remove application servers from the server pool at any time for any reason, there is preferably no server affinity for a user and/or organization to a specific application server 100. In one embodiment, therefore, an interface system (not shown) implementing a load balancing function (e.g., an F5 Big-IP load balancer) is communicably coupled between the servers 100 and the user systems 12 to distribute requests to the servers 100. In one aspect, the load balancer uses a least connections algorithm to route user requests to the servers 100. Other examples of load balancing algorithms, such as round robin and observed response time, also can be used. For example, in certain aspects, three consecutive requests from the same user could hit three different servers, and three requests from different users could hit the same server. In this manner, MTS 16 is multi-tenant, wherein MTS 16 handles storage of different objects and data across disparate users and organizations.

As an example of storage, one tenant might be a company that employs a sales force where each salesperson uses MTS 16 to manage their sales process. Thus, a user might maintain contact data, leads data, customer follow-up data, performance data, goals and progress data, etc., all applicable to that user's personal sales process (e.g., in tenant database 108). In the preferred MTS arrangement, since all of this data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's sales data might be separate from other users' sales data regardless of the employers of each user, some data might be organization-wide data shared or accessible by a plurality of users or all of the sales force for a given organization that is a tenant. Thus, there might be some data structures managed by MTS 16 that are allocated at the tenant level while other data structures might be managed at the user level. Because an MTS might support multiple tenants including possible competitors, the MTS should have security protocols that keep data, applications and application use separate. Also, because many tenants will opt for access to an MTS rather than maintain their own system, redundancy, up-time and backup are more critical functions and need to be implemented in the MTS.

In addition to user-specific data and tenant-specific data, MTS 16 might also maintain system level data usable by multiple tenants or other data. Such system level data might include industry reports, news, postings, and the like that are sharable among tenants.

In certain aspects, client systems 12 communicate with application servers 100 to request and update system-level and tenant-level data from MTS 16 that may require one or more queries to database system 106 and/or database system 108. MTS 16 (e.g., an application server 100 in MTS 16) generates automatically one or more SQL statements (the SQL query) designed to access the desired information.

Each database can generally be viewed as a collection of objects, such as a set of logical tables, containing data fitted into predefined categories. A “table” is one representation of a data object, and is used herein to simplify the conceptual description of objects and custom objects according to one or more embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided. For CRM database applications, such standard entities might include tables for Account, Contact, Lead and Opportunity data, each containing pre-defined fields.

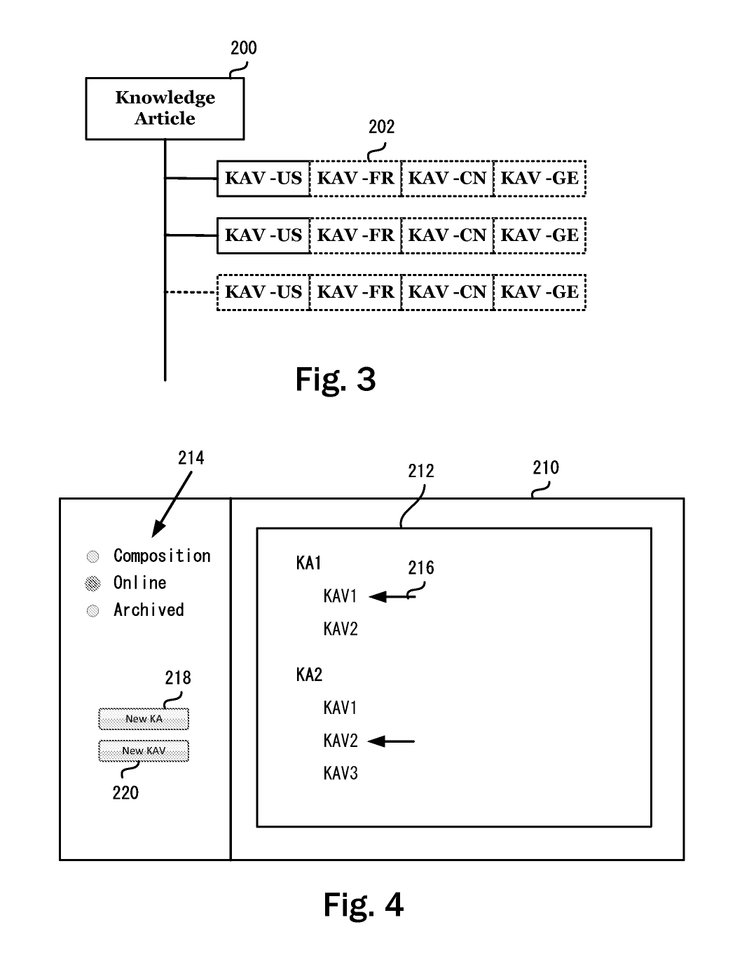

FIG. 3 illustrates an exemplary logical structure of a knowledge article 200. Knowledge Article (KA) 200 is a data container or data structure, to provide metadata storage for one or more Knowledge Article Versions (KAV) 202. KAV 202 is a document that has a distinct version among all other KAVs within KA 200. KA 200 may be stored separate from its children KAVs 202. However, KA 200 may include pointers to its children KAVs 202 that may be stored separate from KA 200.

In a preferred embodiment, knowledge articles (KA) are categorized by data categories. Data categories may be defined in data category groups, each group being a hierarchy of data categories. A KA is assigned a data category to best reflect the content of the KA. A typical data category group may include one or more of the name of a product, level of access, and a topic. The level of access includes whether a KA in a data category group is restricted to some type of users. The topic attribute may include information about the primary objectives of the KA. For example whether the KA is about how to use the product, how to buy the product, how to cancel subscription of a product, etc.

A KA may be categorized under more than one data category group. For example, if the subject matter of the KA span across multiple products, the KA may be categorized under several data category groups, each including a different product. Appropriate search filters may be provided to enable efficient searches by data category groups. For example, a search may be performed for all KAs within a selected data category group, or all KAs within a selected data category group and a selected topic, etc.

A KA type refers to a specific format for the KA. In one embodiment, various templates may be provided to enable users to create new KAs. For example, if a user wishes to create a KA of type “frequently asked questions” (FAQ), a pre-built template may be used. The pre-built template may include fields such as a “Question” field and an “Answer” field. Similarly, a template for creating a new KA regarding product descriptions may include fields such as Picture, Short Description, Long Description, User Manual, etc. These templates may be customized to conform to specific customer requirements. In one implementation, users with appropriate authorization may create new KA type templates.

Referring back to FIG. 3, each KAV 202 may have different versions of itself. In one example, a KAV may have a US English language version and a French language version. A KAV may be translated in any number of languages, each of these translated versions are stored separately. Accordingly, each version of a KAV may be handled independently. Hence, in one embodiment, any changes in the content of one version will not automatically be reflected in the other versions. However, in one embodiment, when a KAV is reassigned to another KA, all versions are reassigned accordingly. In other embodiments, however, each KAV version needs to be reassigned to another KA independently.

KA 200 and KAVs 202 may be stored in a database. Alternatively, KA 200 and KAVs 202 may be stored in a database in MTS 16 environment (FIGS. 1 and 2). Storing KA 200 and KAVs 202 in MTS 16 environment provides sharing of a database among unrelated business entities while keeping a logical data separation among these unrelated business entities. MTS 16 also provides logically separate role and security management.

KA and KAV data structures are configurable, in that new custom fields may be added to these data structures to adapt to specific needs of a particular business entity. Custom fields may be included, for example, to store auditing information, monitoring information, previous actions, and previous actors who acted upon documents encapsulated by KA/KAV structures, etc. KA/KAV may also have locking attributes to limit access or editing of the underlying documents. For example, in one embodiment, only one actor may be allowed to edit a document at a time. In other embodiments, a change log and merging mechanism may be employed if a document is edited by more than one actors at the same time. As used herein, the term “actor” means either a human user or a software component.

FIG. 4 depicts an exemplary graphical user interface (GUI) 210 to enable a user to interact with KAs and KAVs. It should be noted that the GUI 210 may be implemented in several different ways and by using different types of user interface controls. GUI 210 includes radio buttons 214 to filter available KAs and KAVs by their current status. For example, when the “online” button is selected, the user interface pane 212 displays KAs having KAVs with the status “online” in a workflow. In one exemplary embodiment, all KAVs for a KA are displayed in User Interface Pane 212 and a marker 216 is used to indicate a particular KAV with a selected status. In one embodiment, only versions of KAVs with a selected language are displayed. Hence, for example, if a KAV has an English version named “KAV-US” and a French version named “KAV-FR,” only “KAV-US” is shown in the list in User Interface Pane 212 if the selected language is English. Buttons 218, 220 may be provided to enable a user to create a new KA or a new KAV for a selected KA in User interface Pane 212.

Other UI controls 214 may be provided based on a particular configuration of the underlying workflow. For example, if there a workflow state called “validation,” then a control may be provided in GUI 210 to enable filtering of KAs and KAVs based on the status “validation.” In a preferred embodiment, only one KAV of a KA may have a particular status at a given time. For example, only one KAV may have the status “online” at a given time. However, in other embodiments, more than one KAV may have same status.

In one embodiment, GUI 210 is dynamically generated based on login credentials and roles of the logged-in actor. For example, based on the role of the logged-in actor, GUI 210 may or may not display certain KAs and/or KAVs. Roles and permissions are configurable to the extent that a particular group of actors or even individual actors may be accorded the authorization to perform some activities and also may be excluded from performing other activities on KAs and KAVs. For example, a special role may be required for transitioning a document in archived state to composition state. In one embodiment, the role and security management is metadata driven, in that MTS 16 role and security management engine may be configured to specific requirements by uploading metadata that is designed to implement the specific requirements for a particular business entity. The configurations may be stored in individual tenant storage areas 112 (FIG. 2).

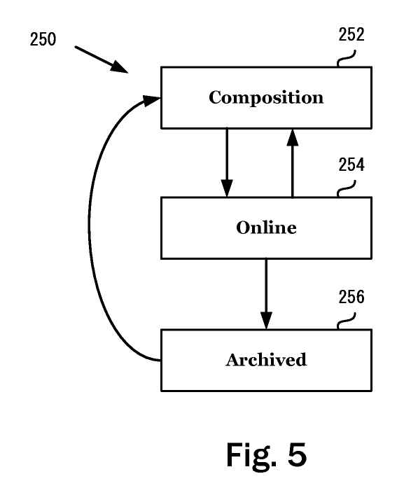

FIG. 5 illustrated an exemplary workflow 250 including a composition state 252, an online state 254 and an archived state 256. Having different states of workflow enables actors with different roles and permissions to work on documents in a managed and organized fashion. A KA may transition from composition state 252 to online state 254 and vice versa. However, a document in archived state 256 may not be suitable for publication without being amended first. Hence, a KA, in one implementation, may not transition back from archived state 256 to online state 254. In this implementation, the KA, however, may transition from archived state 256 back to composition state 252. Transition from one state to another state is triggered by an actor with appropriate permission to perform particular types of transitions. The trigger, in one embodiment, may be as simple as selecting a different state in GUI 210. In addition, a user may have limited permission to selectively transition a KA from one state to another. For example, an actor may have permissions to trigger a transition from composition state 252 to online state 254 but may not have permissions to transition the same document from online state 254 to archived state 256.

In one implementation, workflow 250 is configurable through a set of workflow definition files, which may be in an XML or other format. Workflow definitions may be stored in individual tenant storage areas 112 (FIG. 2). Workflow 250 may execute in tenant process space 104 (FIG. 2).

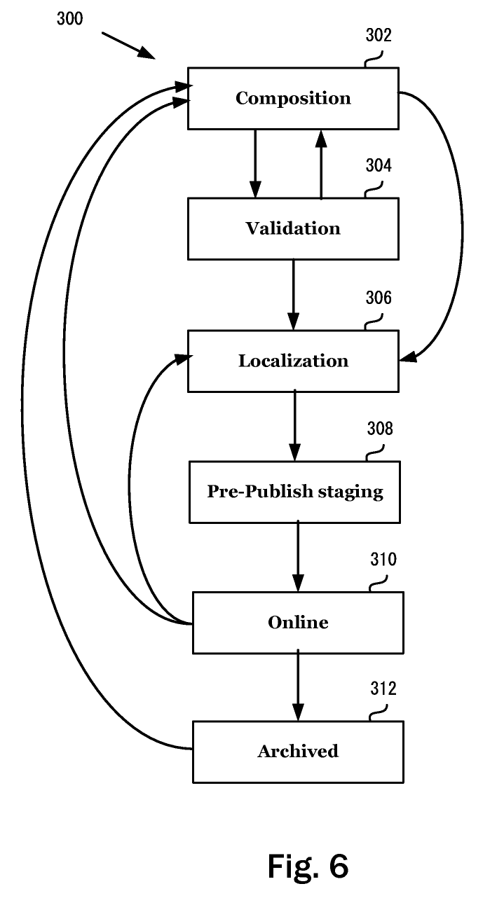

FIG. 6 illustrates another exemplary workflow 300 through which a document may be processed. Workflow 300 includes a composition state 302. In this example, a document in composition state 302 may be transitioned to a validation state 304. In other implementations, it may go through some intermediary states (e.g. a request for comments state). As illustrated, when the document goes through validation, the validation process may be either automated or performed by a user with appropriate role and/or permissions. If validation fails, the document may be sent back to composition state 302 (e.g. the document requires corrections or amendments). In one embodiment, a document may directly be sent to a localization state 306 without going through validation state 304. Such direct transition may require a specific role or permission. Localization state 306 is typically used to enable language translators to work on documents in localization state 306 independently. A document in localization state 306 may be translated in different languages and stored separately. In one embodiment, a pre-publish staging state 308 is provided to hold documents for certain reasons before publishing them. For example, a document may be held in pre-publish staging state 308 for final validation before publishing.

In one implementation, the document may also be time sensitive and may need to be published by a certain date or time. Hence, the document may be held in pre-publish staging state 308 until the predetermined date/time of publication occurs. In one embodiment, a document in pre-publish staging state 308 transitions directly to online state 310. However, a document in online state 310 may transition back to both localization state 306 and composition state 302. Further, a document in online state 310 may also be sent to an archived state 312, from which the document may also transition to composition state 302. Hence, a document remains persistently in the workflow, unless the document is intentionally deleted.

Workflow 300 is configurable to provide different transition states and paths. Further, workflow 300 may also be configured to enable only actors with selected roles and permissions to operate on or transition a document from a particular state to another state. Further, roles may also be defined by data categories. For example, an actor having a role to perform certain actions on documents of a certain data category may not be able to perform the same actions on a different document belonging to a different data category.

In one or more embodiments, workflow state transitions may also include pre-transition triggers, post-transition triggers, or both. These triggers may be used to execute workflow specific or business entity specific pre- or post-state transition tasks, such as sending notifications, updating external systems, updating data in other parts of the workflow system or in MTS 16, and executing custom programming instructions, etc. Further, certain transition states may be configured to disallow pre- or post-transition triggers.

In one or more embodiments, different workflow steps may be invoked for different document categories. Some workflow transition states may be skipped or some more states added based on the document categories or other predefined rules.

In one or more embodiments, a plurality of workflow processes may be configured, each having unique workflow identification. Document categories may be associated with one or more workflow processes, which may beinvoked based on configurable attributes. For example, if a document composition is initiated by an actor with a particular type of role, a pre-selected workflow process may be invoked.

In one or more embodiments, based on a current transition state of a document in the workflow, tasks may be assigned to one or more actors. For example, when a document enters in a validation state, appropriate tasks may be created for actors who are charged with validating certain types of document categories. However, there may be situations when no tasks are assigned. For example, when a document is in the online state, nothing needs to be done for time being. Hence, the workflow engine may not automatically create any task. In such cases, manually triggered transitions would be required. Further, in one embodiment, depending on their type, some transitions may need additional parameters at execution time. For example, when executing a restore to composition transition, the identification of the version to restore has to be transmitted to the workflow engine in order to be forwarded the publishing service. The publishing service may then copy the archived version of the document into a new draft/composition version.

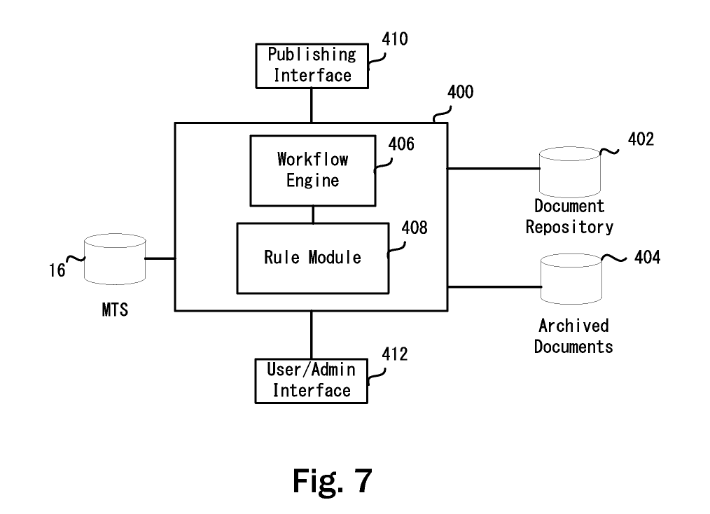

FIG. 7 illustrates an exemplary logically diagram of the system 400 for managing the knowledge article workflow, in one embodiment. System 400 includes a publishing interface 410 to enable digital publication of a document based on the state of workflow. For example, a document in an online status in the workflow is automatically sent for publication through publishing interface 410. Further, when the document is transitioned from the online state to another state, the document is automatically removed from publication.

A User/Admin interface 412 is provided to enable actors to perform workflow tasks on selected documents in the workflow. User/Admin interface 412 may also be used for providing workflow configuration data to a workflow engine 406. A Rule Module 408 is provided to operate the workflow according to predefined rules and configurations. In one embodiment, System 400 may be shared among distinct business entities in MTS 16 environment. In such embodiments, user, role, permissions, configuration, data structures, etc. specific to a particular business entity may be stored in MTS 16, which provides logical separation of data for distinct business entities, including logical separation of security and role management. System 400 may be coupled to a document repository 402 to store documents. KA/KAV data structures may also be stored in document repository 402. In another embodiment, MTS 16 provides document storage. In one embodiment, a separate archived documents database 404 may be provided to store archived documents. However, archived documents may also be stored in document repository 402 or in individual tenant storage areas 112 of MTS 16. In one embodiment, Rule Module 408 and workflow engine 406 may be executed in MTS 16 processing engines.

With the above embodiments in mind, it should be understood that the invention can employ various computer-implemented operations involving data stored in computer systems. These operations are those requiring physical manipulation of physical quantities. Any of the operations described herein that form part of the invention are useful machine operations. The invention also relates to a device or an apparatus for performing these operations. In one embodiment, the apparatus can be specially constructed for the required purpose (e.g. a special purpose machine), or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The embodiments discussed herein can also be defined as a machine that transforms data from one state to another state. The transformed data can be saved to storage and then manipulated by a processor. The processor thus transforms the data from one thing to another. Still further, the methods can be processed by one or more machines or processors that can be connected over a network. The machines can also be virtualized to provide physical access to storage and processing power to one or more users, servers, or clients. Thus, the virtualized system should be considered a machine that can operate as one or more general purpose machines or be configured as a special purpose machine. Each machine, or virtual representation of a machine, can transform data from one state or thing to another, and can also process data, save data to storage, display the result, or communicate the result to another machine.

Implementations can also be embodied as computer readable code on a computer readable medium. The computer readable medium is any data storage device that can store data, which can be thereafter be read by a computer system. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can include computer readable tangible medium distributed over a network-coupled computer system so that the computer readable code is stored and executed in a distributed fashion.

Although the method operations were described in a specific order, it should be understood that other housekeeping operations may be performed in between operations, or operations may be adjusted so that they occur at slightly different times, or may be distributed in a system which allows the occurrence of the processing operations at various intervals associated with the processing, as long as the processing of the overlay operations are performed in the desired way.

Although the foregoing implementations have been described in some detail for purposes of clarity of understanding, it will be apparent that certain changes and modifications can be practiced within the scope of the appended claims. Accordingly, the present embodiments are to be considered as illustrative and not restrictive, and the invention is not to be limited to the details given herein, but may be modified within the scope and equivalents of the appended claims.

1. In a multi tenant database environment, a computer implemented method for a document management workflow, the multi-tenant database environment having a multi-tenant database that is divided into individual tenant storage areas, the method comprising:
receiving instructions to compose a document, wherein the document is encapsulated in a knowledge article version associated with a knowledge article, wherein said knowledge article is associated with a document category;
invoking the document management workflow specific to at least one of the knowledge article, the knowledge article version and the document category;
configuring the document management workflow to include a plurality of workflow steps based on at least one of the knowledge article, the knowledge article version and the document category; and
associating each of the plurality of workflow steps with one or more triggers and actor roles, wherein the actor roles define permissible actions in each of the plurality of workflow steps,
wherein data in the knowledge article and the knowledge article version are configured to be updated with the movement of a document in the plurality of workflow steps,
wherein the document management workflow provides cyclic processing steps with no termination state.

2. The method as recited in claim 1, wherein the plurality of workflow steps includes composition, validation, online, and archive.

3. The method as recited in claim 2, wherein the document is configured to transition from online to composition but configured not to transition from archive to online directly.

4. The method as recited in claim 1, wherein configuration data for the configuring the document management workflow is stored in individual tenant storage areas in a multi tenant system.

5. The method as recited in claim 1, wherein each of the plurality of workflow steps include a pre-transition execution step.

6. The method as recited in claim 5, wherein each of the plurality of workflow steps include a post-transition execution step.

7. The method as recited in claim 6, wherein the one or more triggers include executing the pre-transition execution step.

8. The method as recited in claim 6, wherein the one or more triggers include executing the post-transition execution step.

9. The method as recited in claim 8, wherein the post-transition execution step is used to create tasks to be performed on the knowledge article, the knowledge article version and the document.

10. A computer implemented method a document management workflow in a multi-tenant system environment, the document management workflow including a plurality of transition states, the method comprising:
performing a transition task on a document in a composition state, the transition task being configured to move the document from the composition state to a validation state, the validation state includes an validation task, the document is encapsulated in a knowledge article version and the knowledge article version is associated with a knowledge article;
performing a validation task on the document and then transition the document back to the composition state or to a localization state based on results of the performing of the validation task;
transitioning the document to a pre-publish staging state for holding the document for a period of time before publishing;
transitioning the document from the pre-publish staging state to an online state, wherein the document is published in the online state, the document is configured to stay in the online state for a selected period of time;
transitioning the document from the online state to an archived state after passes of the selected period of time,
wherein the document management workflow is configured to transition from the archived state to the composition state only and the document management workflow is configured with no end point.

11. The method as recited in claim 10, wherein configuration data for the configuring the document management workflow is stored in individual tenant storage areas in a multi tenant system.

12. The method as recited in claim 10, wherein each of the plurality of transition states include a pre-transition execution step.

13. The method as recited in claim 12, wherein each of the plurality of transition states include a post-transition execution step.

14. The method as recited in claim 12, wherein the one or more triggers include executing the pre-transition execution step.

15. The method as recited in claim 12, wherein the one or more triggers include executing the post-transition execution step.

16. The method as recited in claim 14, wherein the post-transition execution step is used to create tasks to be performed on the document.

17. A non-transitory computer readable storage media having programming instructions for a document management workflow in a multi-tenant system environment, the programming instructions comprising programming instructions, which when executed by a microprocessor performs method steps of:
receiving instructions to compose a document, wherein the document is encapsulated in a knowledge article version, the knowledge article version having a document category, the knowledge article version is associated with a knowledge article;
invoking the document management workflow that is specific to the knowledge article, the knowledge article version and the document category;
configuring the document management workflow to include a plurality of workflow steps based on the knowledge article, the knowledge article version and the document category; and
associating each of the plurality of workflow steps with one or more triggers and actor roles, the actor roles define permissible actions in each of the plurality of workflow steps,
wherein data in the knowledge article and the knowledge article version are configured to be updated with the movement of a document in the plurality of workflow steps,
wherein the document management workflow provides cyclic processing steps with no termination state.

18. The non-transitory computer readable storage media as recited in claim 17, wherein the plurality of workflow steps includes composition, validation, online, and archive.

19. The non-transitory computer readable storage media as recited in claim 17, wherein the knowledge article version is configured to transition from online to composition but configured not to transition from archive to online directly.

20. The non-transitory computer readable storage media as recited in claim 17, wherein configuration data for the configuring the document management workflow is stored in individual tenant storage areas in a multi tenant system.
